(19) United States
(12) Patent Application Publication
(10) Pub. No.: US 2006/0032897 A1
(43) Pub. Date: Feb. 16, 2006

(54) Anti-squirt vent hole for a beverage package

(76) Inventor: Anthony P. Cho, Birmingham, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/193,865

(22) Filed: Jul. 28, 2005

Related U.S. Application Data
(60) Provisional application No. 60/591,846, filed on Jul. 28, 2004.

(51) Int. Cl. B65D 77/28; A47G 21/18; A62C 13/62

(52) U.S. Cl. 229/103.1; 239/340; 239/33

(57) ABSTRACT

A container assembly for a liquid has a cavity. The cavity is formed by an interior surface and bounded by an exterior surface. A cavity wall is located between the interior and the exterior surfaces. The cavity wall has a metal foil layer, a plastic layer and a paperboard layer. A straw hole is provided between the interior surface and the exterior surface of the cavity. The straw hole extends through the cavity wall. The air vent is spaced from the straw hole. Both the air vent and the straw hole are located above an anticipated fill level of liquid stored in the cavity. The air vent extends through the cavity wall. A drinking straw is sized to be received by the straw hole and the air vent. A first seal covers the straw hole and a second seal covers the air vent. The first seal and the second seal are configured to be frangible by piercing the drinking straw through the seals.

This application claims priority to U.S. Provisional Patent Application Ser. No. 60/591,846 filed on Jul. 28, 2004.

### BACKGROUND OF THE INVENTION

This invention relates to a beverage container and drinking straw assembly. Aseptic packaging is frequently used to store liquids for later consumption. Such packaging may be in the form of a juice box or juice pouch, which are sealed tightly to ensure that the stored liquid remains fresh. Generally, the packaging is composed of multiple layers of polyethylene, aluminum and/or paper. For a juice box, the paper provides support for the walls of the package while the polyethylene seals the container against leaking. The aluminum provides another sealing barrier against light and oxygen and eliminates the needs for refrigeration. To drink from these packages, typically a consumer punctures a seal that covers a straw hole with a drinking straw. The seal is part of the packaging and may be typically made up of the layers of aluminum foil and polyethylene that constitute the package.

Although the juice box and juice pouch offer convenience in the transportation and consumption of liquid beverages, this type of packaging is not without problems. The juice box and pouch are typically made without sufficient rigidity to prevent a person from squeezing the package, thereby causing the beverage to squirt out of the straw hole. Indeed, these types of packages are aimed at young consumers who often squeeze the packages too tightly and thereby spray juice from the package. It is desirable to eliminate this problem.

In addition, young consumers experience difficulty drawing fluid from the juice box and juice pouch due to the sealed nature of the package. This problem is particularly noticeable as more and more of the beverage is consumed. Indeed, it can be noted that the walls of the package will be drawn inward as beverage is drawn outward. Consumer will often leave a part of the beverage in the package rather than struggle against the package to draw out the beverage's last drops.

It is therefore desirable to have an aseptic package that reduces the tendency of the package to squirt undesirably and facilitate consumption of the liquid within the container.

### SUMMARY OF THE INVENTION

The invention has a cavity for storing liquid. The cavity is formed by an interior surface and bounded by an exterior surface. A cavity wall exists between the interior surface and the exterior surface of the cavity. This wall may have a metal foil layer, a plastic layer and/or a paperboard layer. A straw hole is provided to allow fluid to be drawn from the cavity from the interior surface to the exterior surface of the container. The straw hole extends through the cavity wall. A seal covers this straw hole. A drinking straw is sized to be received by the straw hole and may be used to puncture the seal covering the straw hole to gain access to the liquid in the container.

The container has an air vent spaced from the straw hole. Both the air vent and straw hole are located above an anticipated fill level of the liquid and are both sealed. When an individual chooses to consume liquid from the container, he may pierce both seals with his drinking straw. The air vent reduces the chances that fluid will squirt out of the straw hole because fluid pressure caused by squeezing on the container will be distributed over two holes rather than one, thereby reducing pressure out of any individual hole.

Furthermore, the air vent improves the ability of consumers to draw liquid from the container through a straw. By adding this vent, air may be drawn into the container to depressurize the cavity and allow fluid to be drawn through the drinking straw without drawing the walls of the container inward. In this way, the invention eliminates both problems associated with asceptic packages while maintaining its integrity until consumption.

### BRIEF DESCRIPTION OF THE DRAWINGS

Other advantages of the present invention can be understood by reference to the following detailed description when considered in connection with the accompanying drawings wherein:

FIG. 1 illustrates the inventive container assembly with a straw hole and an air vent, which are both shown sealed.

FIG. 2 illustrates another type of seal for the inventive container assembly.

FIG. 3 illustrates a type of air vent having structure to reduce fluid leakage out of the container.

FIG. 4 illustrates another type of air vent for the inventive container assembly.

FIG. 5 illustrates another air vent having filter paper to reduce fluid leakage out of the air vent.

FIG. 6 illustrates a cross-sectional view of the inventive container assembly with a baffle in a cavity of the container to reduce fluid flow out of the air vent.

FIG. 7 illustrates a cross-sectional view of the inventive container assembly with a check valve to reduce fluid flow out of the air vent.

FIG. 8 illustrates another version of the invention, showing a movable flap that serves to create an air vent.

FIG. 9 illustrates the container assembly of FIG. 8 after the drink straw has punctured a seal by moving the movable flap.

FIG. 10 illustrates an alternative version of the inventive container assembly, illustrating a uniquely shaped straw in a first position.

FIG. 11 illustrates the alternative version of FIG. 12 with straw in a second position.

### DETAILED DESCRIPTION OF THE PREFERRED EMBODIMENT

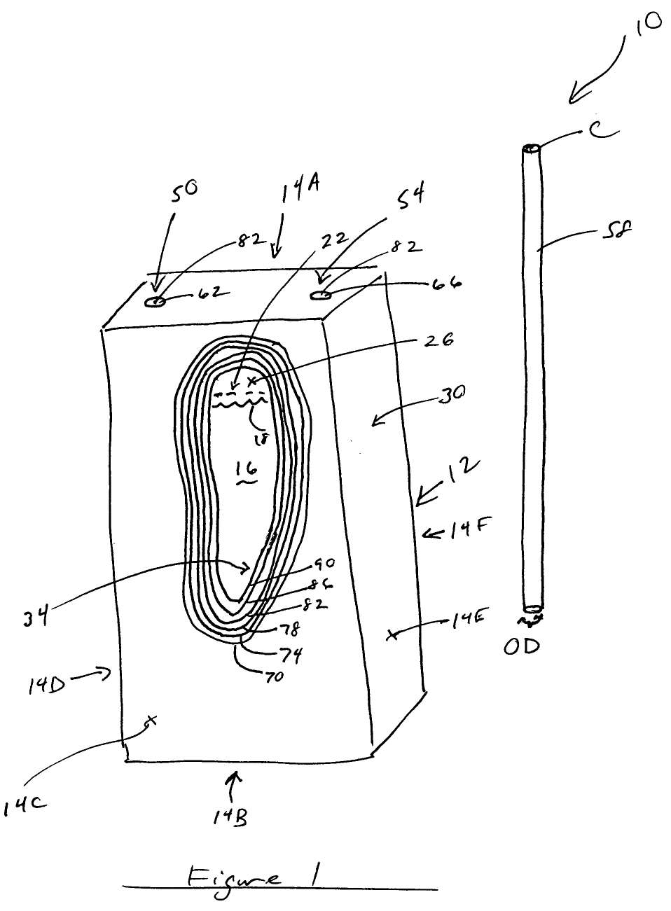

FIG. 1 illustrates container assembly 10. Container assembly comprises box 12 and drinking straw 58. Box 12 has top 14A, bottom 14B, side 14C, side 14D, side 14E and side 14F. Box 12 further has exterior surface 30 and interior surface 26. Interior surface 26 forms cavity 16. Both interior surface 26 and cavity 14 are bounded by exterior surface 30.

Between exterior surface 30 and interior surface 26 is cavity wall 34. As shown in cross-section, cavity wall 34 is made of multiple layers. The outer most layer is a plastic, polyethylene layer 70. This layer provides an outside sealing surface as well as a surface for application of designs and product information. Paperboard layer 74 is provided underneath polyethylene layer 70. Paperboard layer 74 provides rigidity and structure to box 12. Polyethylene layer 78 is another sealing layer, which is followed by aluminum foil 82. Aluminum foil 82 seals against oxygen and light. Polyethylene layer 86 and polyethylene 90 follows these layers.

While box 12 uses polyethylene layers, other plastics may suffice. Further, container assembly 10 may be a pouch or other convenient shape. Paperboard layer 74 is eliminated if the container is a pouch. Also, although aluminum foil 82 is used for box 12, other metal foils may work just as well. Finally, paperboard layer 74 may be comprised of other rigid materials. These features of container assembly 10 are well known.

In addition, box 12 has straw hole 50, which is sized to receive drinking straw 58. To create straw hole 50, paperboard layer 74 may be eliminated thus weakening this area so that drinking straw 58 need only pierce polyethylene layer 70, polyethylene 78, aluminum 82, polyethylene 82, polyethylene 86, and polyethylene layer 90 to obtain access to cavity 16 and liquid 18. Additionally, it may not be necessary to have as many polyethylene layers over straw hole 50 to ensure box 12 remains sealed until use. It is helpful to weaken box 12 in the area of straw hole 50 to facilitate later opening of straw hole 50. In this way, first seal 62 covers straw hole 50 and is frangible by piercing with drinking straw 58 as known.

Due to the polyethylene layers, as drinking straw 58 pierces first seal 62, polyethylene layers 70, 78, 86 and 90 will gather around the circumference C drinking straw 58 and thereby create a seal around the circumference C of drinking straw 58. Applicant has discovered that this seal prevents air from entering cavity 16 making it difficult to draw fluid 18 from cavity 16. Further, this seal between circumference C of drinking straw 58 and straw hole 50 also prevents air from expelling out of cavity 16 except through drinking straw 58, creating a greater chance of fluid 18 squirting through drinking straw 58 in an undesirable fashion.

To eliminate the foregoing problems, box 12 is provided with air vent 54. Air vent 54 may be manufactured in the same way as straw hole 50 and may be sized to receive drinking straw 58. Air vent 54 and straw hole 50 may be similarly sized and extend through cavity wall 34 once punctured. Second seal 66 is provided over air vent 54 and may comprise polyethylene layers 70, 78, 86 and 90 as well as aluminum foil 82 or fewer layers to reduce resistance to puncturing. Paperboard layer 74 may be eliminated over air vent 54 to allow second seal 66 to be pierced by drinking straw 58 in the same manner as straw hole 50. In this way, first seal 62 and second seal 66 are easier to break than said cavity wall 34. Accordingly, when one is ready to consume beverage from box 12, one can pierce both first seal 62 and second seal 66 with the same straw. Straw hole 50 allows fluid to drawn through drinking straw 58 while air vent 54 allows air to enter and leave cavity 16 thereby reducing the chances of undesirable squirting of box 12 and improving the ability to draw liquid 18 through drinking straw 58. It should be noted that straw hole 50 and air vent 54 are both located on top 14A of box 12 above an anticipated fill level 22 of liquid 18. In this manner, puncturing either seal 62 or 66 will not cause liquid 18 to immediately flow out of cavity 16.

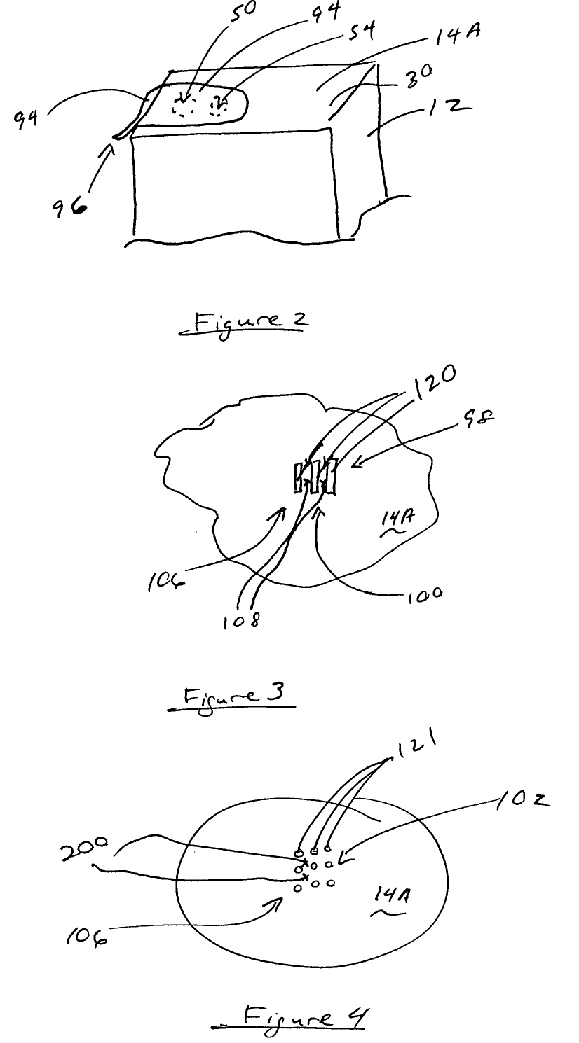

As shown in FIG. 2, in lieu of seal 62 and seal 66, straw hole 50 and air vent 54 may be provided with a removable seal 94, which adheres to top 14A of box 12 on exterior surface 30. Like seals 62 and 66, removable seal 94 is more fragible to breaking open and obtaining access to liquid 18, than by breaking cavity wall 34. A pressure sensitive adhesive or other known adhesive may be used to secure removable seal 94 to top 14A. Straw hole 50 and air vent 54 extend all the way through cavity wall 34 to interior cavity 14 and have no sealing layers other than seal 94. Seal 94 is provided with tab 96 to allow a consumer to easily pull seal 94 off of straw hole 50 and air vent 54 to gain immediate access to liquid 18 within container 12. Removable seal 94 may be two separate seals covering separately straw hole 50 and air vent 54, each seal with its own pull tab. In this way, one need not pierce seals to obtain the benefits of the invention.

FIG. 3 illustrates an alternative air vent 100. Here, grill vent 98 has liquid restricting structures, here bars 108 extending over air vent 100, that reduce the amount of fluid flow out of cavity 16 while still permitting airflow through grill vent 98. In this way, there is a lessening of risk of fluid undesirably leaking out of air vent 100.

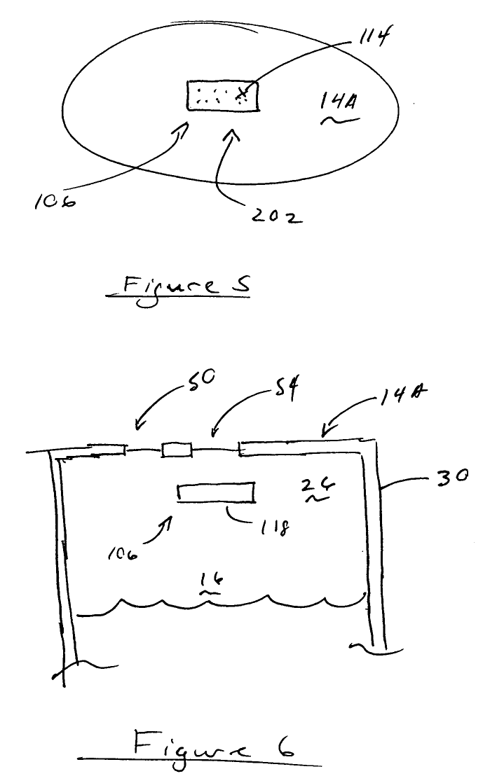

FIG. 4 illustrates another vent 102, here multiple small vent holes 121 that also further reduce fluid flow out of cavity 16. Lands 200 block fluid from leaving cavity 16.

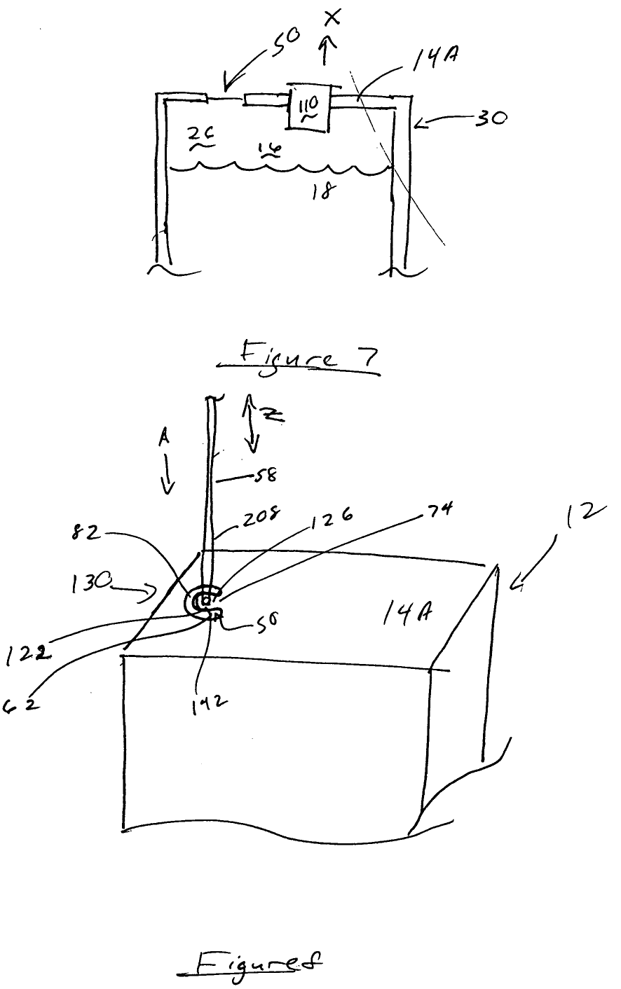

FIG. 5 illustrates another air vent 202. Here, air vent 202 is provided with filter paper 114 to allow air to travel from and to cavity 16 while inhibiting fluid flow out of cavity 16. Filter paper 114 should allow air flow but limit fluid flow.

Additionally, air vent 54 may be constructed in the manner shown in FIG. 1 and have baffle 118, here a planar piece of paperboard or other liquid restricting structure extending perpendicular from interior surface 26, to inhibit fluid flow out of air vent 54 following removal of any seal.

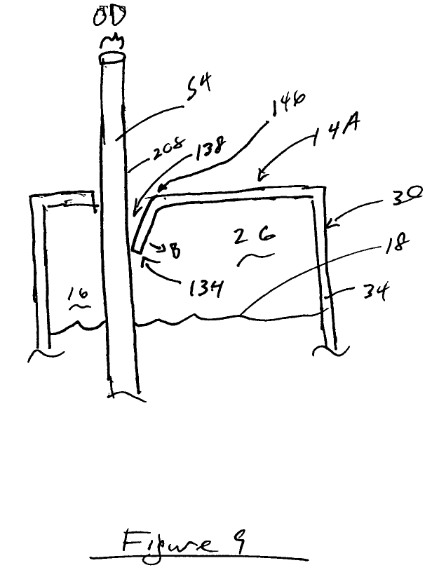

FIG. 7 illustrates box 12 with check valve 110, here a float valve, that allows air to pass into and out of cavity 16 but prevents fluid from flowing out of cavity 16. A floating ball within check valve 110 will float with liquid 18 thereby closing check valve 110 as known, but will only do so when fluid flows in the direction of arrow X. Otherwise, air is permitted to flow though check valve 110.

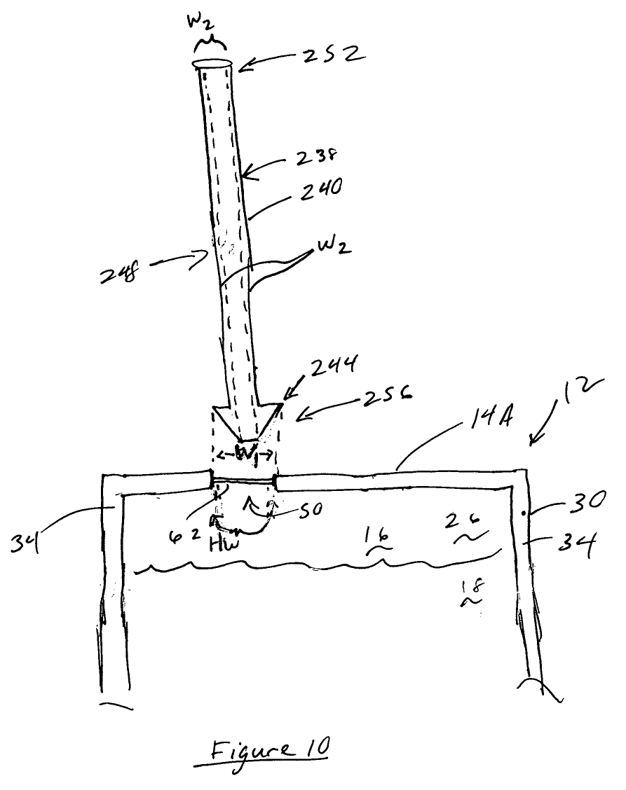

FIG. 8 illustrates an alternative version of the invention. Here, box 12 is provided with movable member 122, which is a tab of paperboard layer 74 of box 12 extending partially over straw hole 50. Straw hole 50 is covered by seal 62, which may simply be aluminum foil 82 although polyethylene layers may be used to further seal straw hole 50. As shown, drinking straw 58 extends along axis Z and has cross-sectional area G, which is the circular area transverse to axis Z. Drinking stray 58 may be positioned over movable member 122. Drinking straw 58 is placed on landing 142 of movable member 122. Landing 142 has area 126, which is larger than cross-sectional area G of drinking straw 58. When drinking straw 58 is pushed down in the direction of arrow A into box 12, movable member 122 will hingedly and pivotally move out of the way of drinking straw 58 in the direction of arrow B as shown in FIG. 9. Because movable member 122 is sized larger than cross-sectional area G of drinking straw 58, a gap 138 will be formed between wall 208 of drink straw 58 and rim 146 of straw hole 50. Gap 138 will act as an air vent that allows air to expel outward of cavity 16 as well as to enter cavity 16.

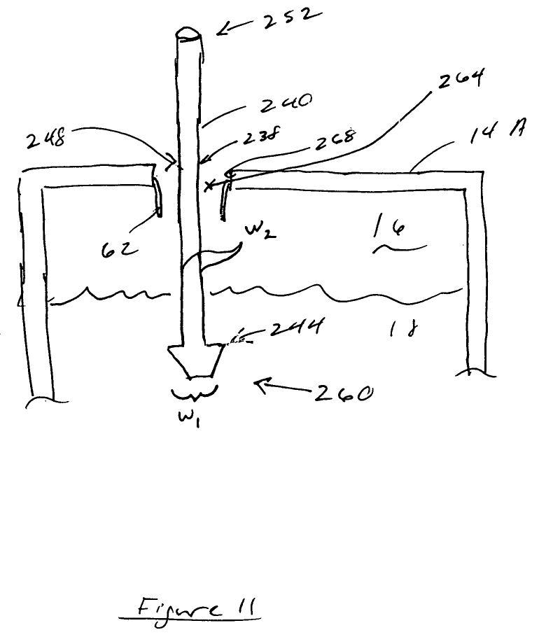

With reference to FIGS. 10 and 11, there is illustrated another version of the invention. Here, the invention is accomplished by a uniquely shaped drinking straw 240. Drinking straw 240 has first end portion 244 spaced by body 248 from second end portion 252. First end portion 244 has its largest width at W₁ and has a frustro conical shape. The smallest width of first end portion 244 is W₂, which is also the width of body 248 and second end portion 252. Straw hole 50 has hole width Hw. Hole width Hw is equal to or greater than first width W₁, which is greater than second width W₂. First hole 50 has first seal 62 manufactured as described previously. In first position 256 shown on FIG. 10, drinking straw 240 is positioned over first seal 62 prior to insertion into cavity 16.

As shown in FIG. 11, drinking straw 240 is then inserted into cavity 16 to break first seal 62 when first end portion 244 has traveled through seal 62 into cavity 16 to second position 244. Due to the oversized head of drinking straw 240, a gap or air vent 264 will be created between rim 268 of straw hole 50 and straw wall 238 of body 248. In this way, an air vent is again created to accomplish the objects of the invention.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A container assembly for a liquid, comprising:
a cavity for storing a liquid having an anticipated fill level, said cavity formed by an interior surface and bounded by an exterior surface;
a cavity wall bounded by said interior surface and said exterior surface, said cavity wall comprising a metal foil layer and a plastic layer;
a straw hole to communicate the liquid between said interior surface and said exterior surface, said straw hole extending through said cavity wall;
an air vent spaced from said straw hole, said straw hole and said air vent located above said anticipated fill level, said air vent extending through said cavity wall;
a drinking straw sized to be received by said straw hole; and
a first seal covering said straw hole and a second seal covering said air vent, wherein said first seal and said second seal are configured to be frangible by piercing said drinking straw through said first seal and said second seal, said first seal and said second seal less resistant to piercing than said cavity wall.

2. The container assembly of claim 1 wherein at least one of said first seal and said second seal comprises said metal foil layer.

3. The container assembly of claim 1 including a paperboard layer, said cavity wall comprising said metal foil layer, said plastic layer and said paperboard layer.

4. The container assembly of claim 1 including a liquid restricting structure for limiting flow of the liquid through said air vent.

5. A container assembly for a liquid, comprising:
a cavity for storing a liquid having an anticipated fill level, said cavity formed by an interior surface and bounded by an exterior surface;
a straw hole to communicate the liquid between said interior surface and said exterior surface;
an air vent spaced from said straw hole, said straw hole and said air vent located above said anticipated fill level;
a removable seal covering said straw hole and said air vent a cavity wall bounded by said interior surface and said exterior surface, said cavity wall comprising a metal foil layer and plastic layer wherein said removable seal is more frangible than said cavity wall.

6. The container assembly of claim 5 including a paperboard layer, said cavity wall comprising said metal foil layer, said plastic layer, and said paperboard layer.

7. The container assembly of claim 5 wherein said removable seal comprises a first seal covering said straw hole and a second seal covering said air vent.

8. The container assembly of claim 5 wherein said removable seal is frangible by piercing said drinking straw through said removable seal.

9. The container assembly of claim 8 wherein said removable seal comprises a metal foil layer.

10. The container assembly of claim 5 wherein said removable seal is located on said exterior surface, said removable seal is frangible by pulling said removable seal from said exterior surface.

12. The container assembly of claim 5 including a liquid restricting structure for limiting flow of the liquid through said air vent.

13. The container assembly of claim 12 wherein said liquid restricting structure comprises a check valve restricting fluid flow out of said cavity.

14. The container assembly of claim 13 wherein said check valve comprises a float valve.

15. The container assembly of claim 12 wherein said liquid restricting structure comprises a filter.

16. The container assembly of claim 12 wherein said liquid restricting structure comprises a baffle spaced between said air vent and said anticipated fill level.

17. The container assembly of claim 5 wherein said removable seal seals both said first opening and said second opening.

18. A container assembly for a liquid, comprising:
a cavity for storing a liquid having an anticipated fill level, said cavity formed by an interior surface and bounded by an exterior surface;
a cavity wall bounded by said interior surface and said exterior surface, said cavity wall comprising a metal foil layer and a plastic layer;
a straw hole to communicate the liquid between said interior surface and said exterior surface, said straw hole extending through said cavity wall;
a frangible seal covering said straw hole;
a drinking straw having an outer wall and extending along an axis, said drinking straw having a cross-sectional area transverse to said axis;
a movable member extending across said straw hole, said movable member having a landing area to receive said drinking straw, said landing area larger than said cross-sectional area of said drinking straw, said movable member having a first position wherein said frangible seal covers said straw hole and having a second position wherein said frangible seal is broken by said movable member, creating an air vent between said outer wall of said drinking straw and said straw hole.

19. The container assembly of claim 18 including a paperboard layer, said cavity wall comprising said metal foil layer, said plastic layer and said paperboard layer, wherein said movable member is formed from said paperboard layer.

20. A container assembly for a liquid, comprising:
a cavity for storing a liquid having an anticipated fill level, said cavity formed by an interior surface and bounded by an exterior surface;
a cavity wall bounded by said interior surface and said exterior surface, said cavity wall comprising a metal foil layer and a plastic layer;
a straw hole to communicate the liquid between said interior surface and said exterior surface, said straw hole extendable through said cavity wall;
a frangible seal covering said straw hole;
a drinking straw having a first end portion spaced by a body from a second end portion, said first end portion having a first width and said body having a second width, said first width larger than said second width; and
wherein said first end portion has a first position and a second position, said first position located outside of said cavity and said second position located inside of said cavity, said frangible seal broken in said second position and an air vent created between a straw wall of said body and a rim of said straw hole.
